(19) United States
(12) Patent Application Publication
(10) Pub. No.: US 2023/0271876 A1
(43) Pub. Date: Aug. 31, 2023

(54) IMPROVED GREENHOUSE GLAZING

(71) Applicant: AGC GLASS EUROPE, Louvain-la-Neuve (BE)

(72) Inventors: Mohammad SHAYESTEH, Gosselies (BE); Fabrice DUFOUR, Gosselies (BE); Vincent LIEFFRIG, Bolinne (BE)

(73) Assignee: AGC GLASS EUROPE, Louvain-la-Neuve (BE)

(21) Appl. No.: 18/041,095

(22) PCT Filed: Aug. 19, 2021
(86) PCT No.: PCT/EP2021/073054

§ 371 Date: Feb. 9, 2023

(30) Foreign Application Priority Data
Aug. 28, 2020 (EP) 20193289.4

(51) Int. Cl. C03C 17/02; A01G 9/14; C03C 23/00

(52) U.S. Cl. CPC C03C 17/02; A01G 9/1438; C03C 23/007; C03C 2217/213; C03C 2203/52

(57) ABSTRACT

The present invention discloses a glazing characterized through a high hemispherical light transmission together with an enhanced tuneable light diffusion, what we hereby call a highly transmitting glazing with optimized Hortiscatter. The glazing of the invention is particularly well suitable for a greenhouse. The invention is a global approach which allows to propose different glazing which can be utilized depending on the type of crop and the geographical zone, providing optimized Hortiscatter on demand

### TECHNICAL FIELD

The present invention relates to improved glazing for greenhouse, that are characterized through a high light transmission together with an enhanced tuned light diffusion, what we hereby call a highly transmitting glazing with optimized Hortiscatter. The invention is a global approach to propose different glazing which can be utilized depending on the type of crop and the geographical zone, providing Hortiscatter on demand.

### BACKGROUND ART

Feeding the increasing World population is more and more a challenge for the agriculture sector. Controlled environment agriculture is an answer to lack of land availability and climate issues. Designing a durable, robust and highly efficient greenhouse performing for its entire lifecycle is therefore very important and such a greenhouse should be convenient for different types of crops and adapted to different climates.

Plant growth requires not only enough carbon dioxide, optimal temperature and humidity but also sufficient photosynthetically active radiation PAR (main part of the light responsible for crop growth corresponding to a wavelength between 400 and 700 nm based on NEN 2675+C1:2018). How sufficient PAR light is transmitted to plant is thus a crucial question. For each geographical situation, orientation, inclination and climate, it is necessary to ensure that durable and efficient optical and thermal properties are provided to plant with help of the greenhouse. Namely one must care that the amount of light transmitted and its distribution inside the greenhouse are homogeneous and ensure enough PAR received on the leaves while avoiding hot points that could damage plants. Another point to consider is that certain plants require more direct light while others, better grow in a more diffused light. That is why beside selection of the correct wavelength (PAR), important characteristics are the hemispherical light transmission (Tₕₑₘ) and also the Hortiscatter. For example in tomatoes, 1% more Tₕₑₘ is responsible for 0.8% more production and 10% more Hortiscatter is responsible for 3% increase of production yield while for soft fruits, high Hortiscatter with the transmission of normal glass has given around 30% improvement in productivity.

As outlined above, an efficient glazing for greenhouses needs to solve different technical problems as wavelength selection, direct and hemispherical transmission as well as light scattering. Glass manufacturers already came with different propositions.

Prior art has disclosed patterned or textured glass to improve light scattering as for example WO2016170261A1 which proposes a calendered glass giving regular features. This solution has the drawback to decrease the light transmission and as a consequence, affect the plant growth.

WO2012134881A1 discloses a textured coated article which allows light with a wavelength greater than 800 nm to scatter to angle below 30° and light with a wavelength smaller than 700 nm to scatter to angle greater than 20°. The idea was to be more selective in the light distribution. To achieve this goal, WO2012134881A1 provides a complicated stack which is further patterned.

Textured glass surface is produced through different means as for example chemical or mechanical etching, hot roll patterning. Different conditions of process result in different glass surfaces characterized by loss of light transmission and a more or less good diffusion. Often light transmission and distribution are antagonist and one has to compromise. We also must consider specular reflection versus specular transmission. BE1001107A4 discloses a glass having a diffused reflection while keeping a high specular transmission resulting from designed pits formed on the glass surface. We need a low reflection whatever specular or diffused and a high transmission with a low specular ratio.

As can be seen, a greenhouse implies a lot of parameters which may be contradictory and despite many solutions have already been proposed, the ideal greenhouse is still to be found and place for improvement still exists. No previous global approach came with a tuneable global solution.

### SUMMARY OF INVENTION

It is an object of the present invention to provide a glazing element that has a high light transmission with a homogeneous and uniform light distribution through a global approach. It has now been discovered that by combining a clear or an extra clear glass having at least one textured surface and at least one silica-based antireflective coating on at least one surface, it was possible, through a synergic effect, to obtain a glazing with a high light transmission and a good light scattering level, what we call our “highly transmitting glazing with optimized Hortiscatter”. Clearly the morphology of the textured surface is very important and is here characterized by its roughness, more particularly by the Sa, Sz and Rsm parameters. Those parameters are better defined in paragraph [0040].

The roughness of the highly transmitting glazing with optimized Hortiscatter of this invention is characterized by the parameter Sa being at least 0.05 μm, preferably at least 0.10 μm and more preferably at least 0.20 μm and being at most 3 μm, preferably at most 2.5 μm and more preferably at most 2 μm.

The roughness of the highly transmitting glazing with optimized Hortiscatter of this invention is characterized by the parameter Sz being at least 1 μm, preferably at least 2 μm and more preferably at least 3 μm and being at most 12 μm, preferably at most 10 μm and more preferably at most 9 μm.

The roughness of the highly transmitting glazing with optimized Hortiscatter of this invention is also characterized by the parameter Rsm being at least 50 μm, preferably at least 55 μm and more preferably at least 60 μm and being at most 150 μm, preferably at most 140 μm and more preferably at most 130 μm.

The highly transmitting glazing with optimized Hortiscatter of this invention has an hemispherical light transmission of at least 75%, preferably 78% and more preferably 80%.

As another advantage, the inventors have discovered that the glazing of the invention has an enhanced hydrophilicity, characterized by a water contact angle that is quite low. This property is a result of combining textured surface with nano-porous anti-reflective coating, allowing water inside the greenhouse to form a film instead of drops and as a result, elevating the hemispherical light transmission in wet condition. The effect is important as explained below.

During a sunny day the glass temperature is rather higher than the dew point and hence no condensation occurs on the inner side of the glass. In this condition a highly transmitting glazing with optimized Hortiscatter causes the light scattering to be at highest level initially designed for that glazing ensuring the effective light distribution inside the greenhouse. In this case light can penetrate deep into the crop canopy reaching the lower leaves and improving the photosynthesis rate. Namely, the upper leaves cannot cast shadow on the lower ones, resulting also in morphology of the leaves being more horizontally oriented as compared to the condition when the light comes inside the greenhouse without diffusion. On the other hand when there is a cloudy day, the glass temperature is lower than the dew point resulting in condensation occurring on the inner side of the glass. In this case and in a surprising way, the highly transmitting glazing with optimized Hortiscatter of this invention becomes more transparent and reduces the scattering effect whereas the light coming from sky is already scattered by the clouds and there is no longer need for glazing to scatter further. In this case the highly transmitting glazing with optimized Hortiscatter of the invention provides higher hemispherical transmission. This effect is demonstrated in the detailed description.

Thanks to this hydrophilic property, the so called rain effect inside the greenhouse may be avoided. Advantageously, the water contact angle of the coated surface of the highly transmitting glazing with optimized Hortiscatter of the invention is at most 32°, preferably at most 30° and more preferably at most 28°.

This particular hydrophilicity, due to the glass texturation assisted by the nano-porosity of antireflective coating, is particularly durable.

Another advantage of using our specific anti-reflective coating on the textured glass is responsible for a better protection against glass corrosion which makes the glazing of the invention more durable.

In a first embodiment the at least one textured surface is combined with one nano-porous silica-based antireflective layer. Advantageously, the nano-porous silica-based anti-reflective layer is a single layer deposited on the textured surface.

In a preferred first embodiment when a single glass surface is textured and a single antireflective coating is deposited, the single antireflective coating is deposited on the textured surface, this particular textured coated surface is designed to be oriented to the interior of the greenhouse, in the position the man skilled in the art is used to name the P2 position.

In a second embodiment the at least one textured surface is combined with two nano-porous silica-based antireflective layers being deposited on each surface of the glazing. Advantageously, each nano-porous silica-based anti-reflective layer is a single layer.

In a preferred second embodiment, the textured surface is designed to be oriented to the interior of the greenhouse, in the position the man skilled in the art is used to name the P2 position

In a third embodiment both surfaces of the glass substrate are textured and one of the textured surface is combined with one nano-porous silica-based antireflective coating.

In a preferred third embodiment the coated textured surface characterized by a higher roughness, is oriented to the interior of the greenhouse, in the position the man skilled in the art is used to name the P2 position. The coated side with a higher roughness is characterized by higher Sa and Sz value.

In a more preferred third embodiment, the nano-porous silica-based antireflective coating is a single layer coating and is deposited on the surface with the higher roughness or in the P2 position.

In a fourth embodiment both glass surfaces are textured and each of the textured surface is covered with a nano-porous silica-based antireflective coating. The coated textured surface characterized by a higher roughness, is oriented to the interior of the greenhouse, in the position the man skilled in the art is used to name the P2 position. The coated side with a higher roughness is characterized by with a higher Sa and Sz value.

In a preferred fourth embodiment, each nano-porous silica-based anti-reflective layer is a single layer.

It has been found that by adjusting the glass surface texture, it was possible to vary the Hortiscatter and the hemispherical light transmission in such a way that an optimized greenhouse glazing may be provided for any type of crop in any type of geographical zone.

The specifications of the glazing of this invention are summarized in the table 1. The performance of our product is assessed through the hemispherical light transmission and the Hortiscatter (expressed in percent). Our product is characterized by its roughness and in particular by the Sa, Sz and Rsm parameters (expressed in μm), which impact the Hortiscatter. The glazing of the invention is also characterized by the water contact angle on its surface to assess the hydrophilicity. These wide possibilities allow to propose Hortiscatter on demand to fulfil the requirements of the different crops and geographical zones.

TABLE 1
Specification of the highly transmitting glazing
with optimized Hortiscatter of the invention

| | preferred | More preferred | Most preferred |
|---|---|---|---|
| Hemispherical | >75% | >78% | >80% |
| light transmission | | | |
| Hortiscalter level | 0.5-80% | 2.0-78% | 4.0-75% |
| Roughness Sa | 0.05-3 | 0.1-2.5 | 0.2-2 |
| Roughness Sz | 1-12 | 2-10 | 3-9 |
| Roughness Rsm | 50-150 | 55-140 | 60-130 |
| Water contact | <32° | <30° | <28° |
| angle (P2) | | | |

For any embodiment, in a first step, one (or both) glass surface is textured and the at least one nano-porous silica-based anti-reflective layer is deposited to one or both surfaces. Before heat treatment, the nano-porous silica-based anti-reflective layer has a carbon weight content greater than 20%, preferably greater than 25%, more preferably greater than 30% and most preferably greater than 35%.

For any embodiment, in a second step, the glazing is heat treated at a temperature comprised between 350° C. to 750° C., preferably between 500° C. and 700° C. and more preferably between 620° C. and 680° C. The heat treatment is performed during 5 to 20 minutes. After heat treatment, the silica-based low reflective layer has a refractive index not greater than 1.48, preferably not greater than 1.45, more preferably not greater than 1.40 and most preferably not greater than 1.38.

### BRIEF DESCRIPTION OF DRAWINGS

This and other aspects of the present invention will now be described in more detail, with reference to the appended drawings and by showing various exemplifying embodiments of the invention.

FIG. 1 shows the different surface structures providing different Hortiscatter levels.

FIG. 2 shows the correlation between the roughness and the Hortiscatter

FIG. 3 is a comparison of hemispherical transmission as a function of Hortiscatter for single AR and double AR coated glass with various textured surfaces.

FIG. 4 shows the PAR light transmission at different angles of incidence for incoming light for the glass with reference 2 and 5 described in Table 2.

FIG. 5 shows the evolution of the light transmission before and after the brush cleaning test.

### DESCRIPTION

The features of our invention are the consequence of a combination of glass quality, glass surface treatment and antireflective coating. Each of those characteristics will now be described with more details.

### Definitions

PAR meaning is Photosynthetically active radiation and comprises wavelength between 400 to 700 nm, based on NEN 2675+C1:2018. This is the main part of natural light responsible for photosynthetic activities of plants.
Within the context of horticulture, Hortiscatter is the integral value of geometrical distribution of light intensity by bi-directional transmittance (or reflectance) distribution function BTDF under a given angle of incidence of incoming light beam (3D data), defined by Wageningen University and Research (WUR) in the standard NEN 2675+01:2018.
Hemispherical light transmission (Tₕₑₘ) and haze are measured following the standard NEN 2675+01:2018. The hemispherical light transmission is a measure of light transmission at different angles from the point of light incidence.
The refractive index n is calculated from the light spectrum wavelength at 550 nm.
The roughness is characterized through the Sa, Sz and Rsm values (expressed in micrometers). The roughness parameters were measured by confocal miscroscopy. The surface parameters (Sa and Sz) according to ISO 25178 standard, and the profile parameter (Rsm) by isolating a 2D profile which then gives access to the parameters defined in the ISO 4287 standard. Alternatively, one can use a 3D profilometer for the surface parameters (according to the ISO 25178 standard) and a 2D profilometer for the profile parameters (according to the ISO 4287 standard). The texture/roughness is a consequence of the existence of surface irregularities/patterns. These irregularities consist of bumps called “peaks” and cavities called “valleys”. On a section perpendicular to the etched surface, the peaks and valleys are distributed on either side of a “center line” (algebraic average) also called “mean line”. In a profile and for a measurement along a fixed length (called “evaluation length”).
   Sa (arithmetic mean height) expresses, as an absolute value, the difference in height of each point compared to the arithmetical mean of the surface, the Sa parameter is characterized by a standard deviation of 0.1 μm;
   Sz (maximum height) is defined as the sum of the largest peak height value and the largest pit depth value within the defined area, the Sz parameter is characterized by a standard deviation of 0.6 μm;
   Rsm (spacing value, sometimes also called Sm) is the average distance between two successive passages of the profile through the “mean line”; and this gives the average distance between the “peaks” and therefore the average value of the widths of the patterns, the Rsm parameter is characterized by a standard deviation of 1.0 μm.
The water contact angle is the angle made between the tangent to a water drop and the surface of the support. The measure is made following the standard method ASTM C 813-75 (1989)
Durability of the coating is assessed by means of the Brush Cleaning Test. The testing procedure is made by analogy to ISO 11998 and ASTM D2486 standards and the brush specifications is according to ASTM D2486 (Nylon 454 g). The effective scrubbing length is 70 mm, the test frequency is 2 Hz and the speed about 24 cm/s (based on DIN EN 1096-2 Appendix E). ISO 12103 defines the uniform distribution of initial 1 g dry Arizona Test Dust fine on the glass surface, with re-deposition of 0.5 g of dust every 100 cycles. Typical set of test cycles are 100, 200, 300, 400 and 500.

The glass used for the invention is a clear glass or an extra clear glass. The clear glass has a composition characterized by an iron content expressed in weight percent of Fe₂O₃ which is at most 0.1%. This value drops to at most 0.015% for the extra clear glass. The glass substrate of the invention has a thickness that is greater than 1 mm, preferably greater than 1.5 mm and more preferably greater than 2 mm. The thickness of the glass substrate is at most 20 mm, preferably at most 15 mm and more preferably at most 10 mm. Advantageously the thickness of the glass substrate is comprised between 3 and 6 mm. A 4 mm glass substrate with the extra clear composition has a light transmission of about 91.7%.

At least one surface of the glass has been textured through a mechanical or a chemical process, by methods well known from the man skilled in the art. The textured surface may be manufactured through calendering, sand blasting or chemical etching. Chemical etching may be performed by any known procedure in the art such as dipping, spraying, roller etching, curtain etching.

For example, texturing may be obtained by means of a controlled chemical attack with an aqueous solution based on hydrofluoric acid, carried out one or more times. Generally, the aqueous acidic solutions used for this purpose have a pH between 0 and 5 and they can comprise, in addition to the hydrofluoric acid itself, salts of this acid, other acids, such as HCl, H₂SO₄, HNO₃, CH₃CO₂H, H₃PO₄ and/or their salts (for example, Na₂SO₄, K₂SO₄, (NH₄)₂SO₄, BaSO₄, and the like), and also other adjuvants in minor proportions. Alkali metal and ammonium salts are generally preferred, such as, for example, sodium, potassium and ammonium bifluoride. The acid etching stage according to the invention can advantageously be carried out by controlled acid attack, for a time which can vary as a function of the acid solution used and of the expected result.

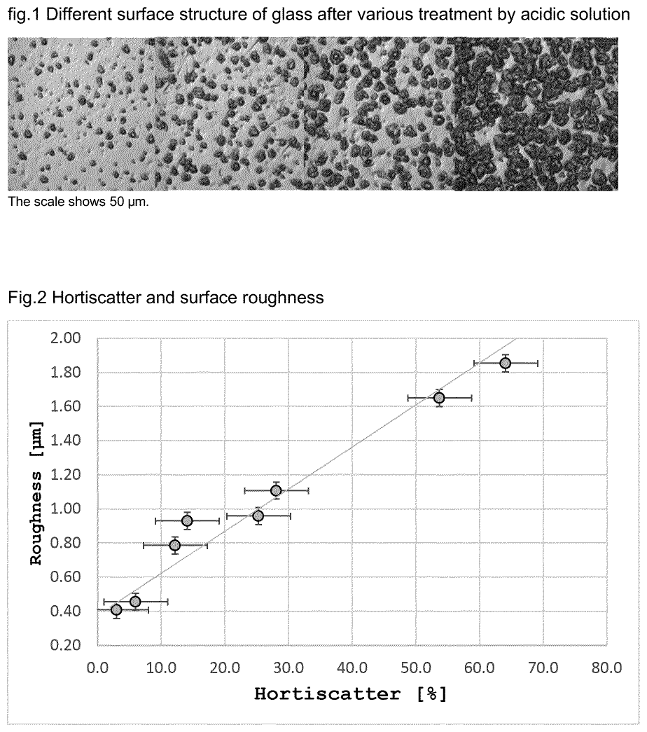

Specific textured surface are achieved (see FIG. 1) and are responsible for various level of Hortiscatter. The table 2 indicates the resulting Hortiscatter and the hemispherical light transmission obtained regarding the texture of one or both surfaces of the glass, the texture being here characterized through its roughness parameters Sa, Sz and Rsm. Absence of value means no texturation has been performed. In all cases, the glazing is either coated with a single nano-porous silica-based antireflective layer on the textured so called air-side glass surface or coated with a double nano-porous silica-based antireflective layer on both air-side and tin-side of the glass. Air-side or tin-side referred to the surface of the glass being in contact with the tin bath or the face in air contact during the float process. Hortiscatter value expressed in percent is given with a range of ±5% and hemispherical transmission value expressed in percent is given with a range of ±0.5%. The AR column is indicating presence or not of an antireflective coating. The references given in the first column will be kept for the rest of the description, meaning for example that “1” refers to the single side textured glass surface having an Hortscatter of 3.0% and a Tₕₑₘ of 85.4%.

TABLE 2

| | Air-side | | | | Tin-side | | | | | |
|---|---|---|---|---|---|---|---|---|---|---|
| | Sa | Sz | Rsm | | Sa | Sz | Rsm | | Hortiscatter | Tₕₑₘ |
| ref | (μm) | (μm) | (μm) | AR | (μm) | (μm) | (μm) | AR | (%) | (%) |
| 1 | 0.205 | 3.763 | 110 | yes | — | — | — | no | 3.0 | 85.4 |
| 2 | 0.653 | 5.573 | 78 | yes | — | — | — | no | 14.0 | 84.0 |
| 3 | 0.857 | 6.163 | 80 | yes | — | — | — | no | 28.0 | 82.9 |
| 4 | 1.557 | 8.600 | 76 | yes | — | — | — | no | 65.0 | 79.8 |
| 5 | 0.218 | 3.610 | 89 | yes | 0.240 | 3.603 | 84 | no | 13.5 | 84.3 |
| 6 | 0.571 | 5.337 | 88 | yes | 0.464 | 4.623 | 98 | no | 31.6 | 82.8 |
| 7 | 0.696 | 5.900 | 64 | yes | 0.965 | 6.663 | 73 | no | 59.2 | 80.8 |
| 8 | 1.490 | 8.653 | 72 | yes | 1.460 | 8.133 | 68 | no | 75.1 | 78.3 |
| 9 | 0.227 | 3.483 | 84 | yes | 0.565 | 5.217 | 66 | no | 25.5 | 83.0 |
| 10 | 0.240 | 3.530 | 109 | yes | 0.885 | 6.377 | 65 | no | 41.2 | 81.8 |
| 11 | 0.227 | 3.497 | 130 | yes | 1.713 | 9.397 | 65 | no | 68.9 | 78.9 |
| 12 | 0.483 | 4.707 | 79 | yes | 0.921 | 6.443 | 69 | no | 47.0 | 81.5 |
| 13 | 0.482 | 5.020 | 77 | yes | 1.763 | 9.060 | 63 | no | 70.1 | 79.0 |
| 14 | 0.753 | 5.570 | 73 | yes | 1.680 | 9.450 | 68 | no | 72.2 | 78.5 |
| 15 | 0.220 | 3.610 | 116 | yes | — | — | — | yes | 6.0 | 87.7 |
| 16 | 0.603 | 5.360 | 84 | yes | — | — | — | yes | 12.2 | 87.0 |
| 17 | 0.919 | 6.250 | 71 | yes | — | — | — | yes | 25.3 | 85.8 |
| 18 | 1.600 | 8.350 | 78 | yes | — | — | — | yes | 53.7 | 83.5 |

The table 2 shows that the different texturations primarily applied on one side of the glass covers a wide range of Hortiscatter. The application of those texturations on the other side of the glass also enables the full coverage of Hortiscatter range with a particular hemispherical transmission value. Combination of both textured glass surfaces offers huge possibilities in terms of resulting hemispherical light transmission and Hortiscatter.

The nano-porous silica-based antireflective coating may be deposited by any known mean. In a preferred embodiment the nano-porous silica-based antireflective layer is a SiOₓ nano-porous layer deposited as described in EP1679291B1 and in DE10159907A1, both incorporated here by reference. The nano-porous SiOₓ film will get its final optical and mechanical properties in a two-step production. At first, in the as-deposited state the thin film is coated by a PECVD process and results in high carbon content SiOₓC_{y} coating, the layer comprises 5 to 30 at. % of Silicon, 20 to 60 at. % of Oxygen, 2 to 30 at. % of carbon and 2 to 30 at. % of hydrogen.

In order to get the final optical and mechanical properties one needs to bake the glass and the film. The carbon is desorbed during the tempering process leaving increased porosity, pores having a mean diameter greater than 5 nm. Increasing porosity results in a smaller refractive index, responsible for the antireflective performance. Preferably, after tempering the refractive index of the SiOₓ layer is at most 1.5, preferably at most 1.4 and more preferably at most 1.38. Temperatures for any heat strengthened glass are between 650° C.-680° C. During this tempering process the organic parts will desorb from the coating and leave a porous SiO₂ film. Advantageously, the final refractive index is 1.37.

Advantageously, the thickness of the heat treated nano-porous silica-based layer is at least 80 nm, preferably at least 90 nm and more preferably at least 100 nm. The thickness of the silicon oxide based layer is at most 180 nm, preferably at most 140 nm and more preferably at most 120.

Advantageously, the film thickness after bake is around 110 nm (±5 nm). Based on the special plasma process the surface of the glass together with the coating will be densified. The chemical bond between the Si group in the coating and the Si group on the surface of the glass at the interface of coating-glass surface is the main reason on the better mechanical durability performances. Furthermore regarding the mechanical behaviour, the coating after bake is harder than the uncoated float glass.

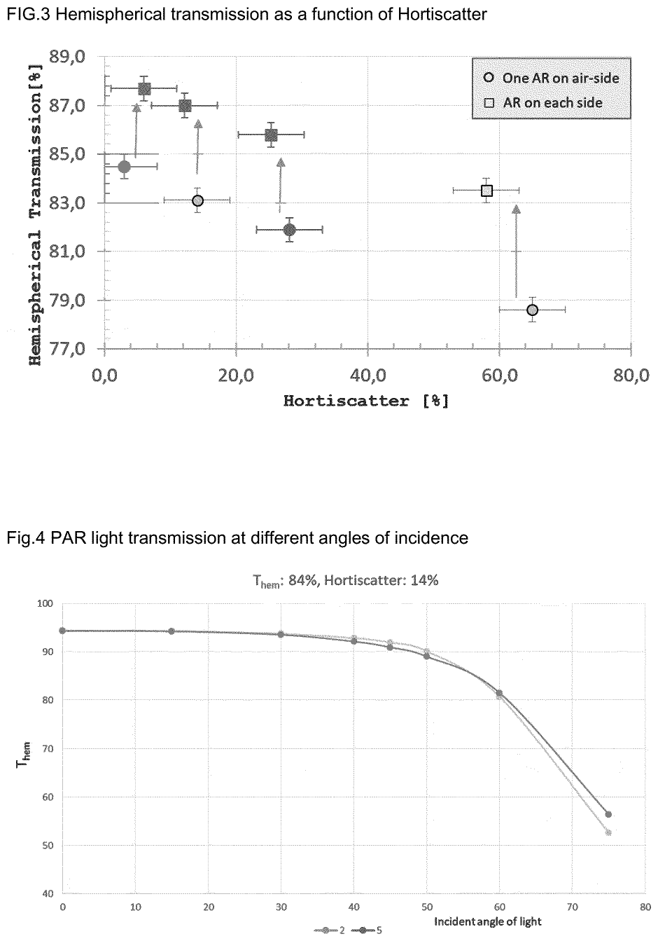

The inventors have discovered that addition of a second nano-porous anti-reflective coating on the second glass surface allows to enhance the hemispherical light transmission by as much as 5% while preserving the Hortiscatter. The 110 nm film thickness results in a maximum hemispherical transmission greater than 89% for a double-sided anti-reflective coated extra clear glass which is more than 5% higher than the uncoated extra clear glass. This is better illustrated on FIG. 3.

Preservation of the Hortiscatter is due to the presence of special microstructure implemented by texturing the glass surface while the nano-porosity of the anti-reflective coating is only improving the hemispherical light transmission. Moreover the nano-porous anti-reflective coating is also protecting the textured surface from corrosion by acting as diffusion barrier for volatile species inside the core glass, giving enhanced chemical and mechanical durability which enable the longer performance with the minimized deterioration rate, being in line with class A coating based on the norm EN 1096-2.

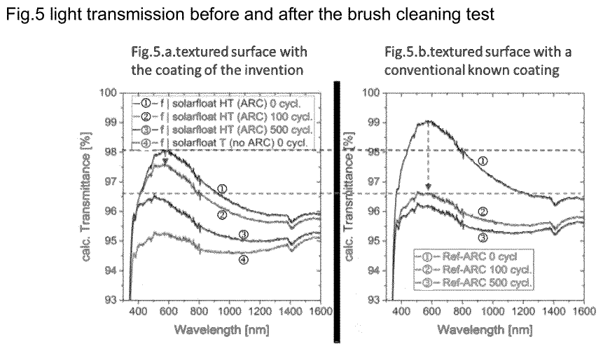

The brush cleaning test has been performed on the glazing of the invention and by comparison on a similar textured glazing covered with a known conventional antireflective coating. The FIG. 5 shows that addition of an antireflective coating (ARC) on the textured glass surface increases the light transmission (compare curve solarfloat T (no ARC) with solarfloat HT, FIG. 5.a). FIG. 5, a and b also show that the brush test is responsible for a decrease in light transmission, most probably due to the coating degradation. Nevertheless, the coating of the invention proves to be more durable since the light transmission after 500 brush cycles is comparable with the light transmission of the conventional antireflective coating submitted to only 100 brush cycles.

The FIG. 4 shows that for equivalent hemispherical light transmission and equivalent Hortiscatter, the light transmission related to the angle of incident light has a different type of distribution related to the presence of a single side or a double sides textured glazing (compare examples 2 and 5). This particular behaviour is an opportunity of better choosing the optimized glazing related to the geographical zone. A single side glass textured is more performant for light transmission at lower angle (closer to the normal incidence) while a double sides textured glazing is a more effective light capture at the higher angle of incidence while both represent the same value for hemispherical light transmission and Hortiscatter. For the particular examples of FIG. 4, the enhanced light transmission at higher angle of incidence could be of importance for the regions with sun always shining at the very low angle versus horizon (correspond to the Ref 2 in table 2) and by opposite the curve #5 (Ref 5 in table 2) present a higher transmission at a smaller incident angle.

As already pointed previously, when the glass surface is wet, the hemispherical light transmission slightly increases. When the textured glass surface is coated with an anti-reflective coating of the invention, the increase is still greater (see table 3).

TABLE 3

| | Difference Tₕₑₘ of | |
|---|---|---|
| | wet material compared to | Condensation |
| Ref | dry material (ΔTₕₑₘ) | effect ** |
| 1 | 0.5% | +/− |
| 2 | 0.2% | +/− |
| 3 | −0.1%* | +/− |
| 4 | 0.1% | +/− |
| 15 | 0.2% | +/− |
| 16 | 0.2% | +/− |
| 17 | 0.6% | + |
| 18 | 2.25% | ++ |

*a minus sign means that Tₕₑₘ is decreasing when the surface is wet
** The condensation effect is defined as follow: (− −) very negative < −2%; (−) negative −2% to −0.5%; (+/−) neutral −0.5% to +0.5%; (+) positive +0.5% to +2%; (+ +) very positive > +2%

### Description of Embodiments/Examples

The following examples have been made in accordance with the invention.

Example 1 (table 2, Ref 2). A 4 mm thick sheet of extra-clear glass has been washed with deionized water and then dried. An acid etching solution, composed by volume of 50% NH₄HF₂, 25% water, 6% concentrated H₂SO₄, 6% of a 50% by weight aqueous HF solution, 10% K₂SO₄ and 3% (NH₄)₂SO₄, at 20-25° C., was allowed to contact the glass surface for 1.5 minutes. After removal of the acid solution, the glass surface is rinsed with water and washed. The textured glass sheet is then transferred to a coating line where a single SiOₓC_{y} layer is deposited by a PECVD method as described in EP1679291B1 and heat treated at a temperature between 650° C. and 680° C. during 15 minutes. Basic coating material is an HMDSO which is heated up in an evaporator outside the line to transfer the chemical fluid from liquid to the gas phase in combination with an plasma in vacuum atmosphere comprising oxygen and forming an amorphous SiOₓ film with high organically content on the glass surface. The film thickness after bake is around 110 nm (±5 nm).

Example 2 (table 2, Ref 3) is made following the same procedure as example 1 except that the contact time of the acid solution with the glass surface is 2 minutes.

Example 3 (table 2, Ref 5) is made following the same procedure as example 1 except that both glass surfaces have been contacted during 1 minute by the acid solution. The air-side surface is then coated with a 110 nm thick SiOₓC_{y} layer following the same procedure described in example 1.

Example 4 (table 2, Ref 15) is the same as example 3 except that only the air-side surface is textured through contact with the acid etching solution during 1.5 minutes and that both surfaces have been coated with the antireflective SiOₓC_{y} layer.

1. A highly transmitting glazing with optimized Hortiscatter having combined features comprising (a) a clear glass quality, (b) a textured glass-surface, and (c) at least one silica-based anti-reflective layer on at least one surface, said textured glass surface being characterized by:
(a) a Sa parameter being at least 0.05 μm and at most 3 μm,
(b) a Sz parameter being at least 1 μm and at most 12 μm,
(c) a Rsm parameter being at least 50 μm and at most 150 μm.

2. The highly transmitting glazing with optimized Hortiscatter of claim 1 such that the at least one textured surface has a roughness characterized by a Sa parameter being at least 0.1 μm, preferably at least 0.2 μm and at most 2.5 μm, preferably at most 2 μm.

3. The highly transmitting glazing with optimized Hortiscatter of claim 1 such that the at least one textured surface has a roughness characterized by a Sz parameter being at least 2 μm, preferably at least 3 μm and at most 10 μm, preferably at most 9 μm.

4. The highly transmitting glazing with optimized Hortiscatter of claim 1 such that the at least one textured surface has a roughness characterized by a Rsm parameter being at least 55 μm, preferably at least 60 μm and at most 140 μm, preferably at most 130 μm.

5. The highly transmitting glazing with optimized Hortiscatter of claim 1 such that only one glass surface is textured.

6. The highly transmitting glazing with optimized Hortiscatter of claim 1 with both surfaces being textured.

7. The highly transmitting glazing with optimized Hortiscatter of claim 5 characterized in that light capture is more efficient with an incident light at 30° to 60°

8. The highly transmitting glazing with optimized Hortiscatter of claim 6 characterized in that light capture is more efficient with an incident light greater than 60°

9. The highly transmitting glazing with optimized Hortiscatter of claim 1 such that the difference of the hemispherical light transmission of the wet textured surface is at most 0.1% less than the hemispherical light transmission of the dry textured surface.

10. The highly transmitting glazing with optimized Hortiscatter of claim 1 such that the hemispherical light transmission of the wet textured surface is higher than the hemispherical light transmission of the dry textured surface.

11. The highly transmitting glazing with optimized Hortiscatter of claim 1 such that the hemispherical light transmission of the wet textured surface is at least 0.5% higher than the hemispherical light transmission of the dry textured surface.

12. The highly transmitting glazing with optimized Hortiscatter of claim 1 such that both surfaces are coated with a silica-based anti-reflective layer.

13. The highly transmitting glazing with optimized Hortiscatter of claim 1 characterized in that the silica-based anti-reflective layer is the only layer deposited on the at least one surface.

14. The highly transmitting glazing with optimized Hortiscatter of claim 1 characterized in that the silica-based anti-reflective layer before heat treatment has a carbon weight content greater than 20%, preferably greater than 25%, more preferably greater than 30% and most preferably greater than 35%

15. The highly transmitting glazing with optimized Hortiscatter of claim 1 such that the at least one silica-based low reflective layer has a refractive index not greater than 1.48, preferably not greater than 1.45, more preferably not greater than 1.40 and most preferably not greater than 1.38.

16. The highly transmitting glazing with optimized Hortiscatter of claim 1 having an hemispherical light transmission greater than 75%, preferably greater than 78% and more preferably greater than 80%.

17. The highly transmitting glazing with optimized Hortiscatter of claim 1 having an Hortiscatter comprised between 0.5 and 80%, preferably between 2 and 78% and more preferably between 4 and 75%.

18. The highly transmitting glazing with optimized Hortiscatter of claim 1 with the at least one silica-based anti-reflective layer on at least one surface, said one surface being characterized by a water contact angle being at most 32°, preferably at most 30° and more preferably at most 28°.

19. The highly transmitting glazing with optimized Hortiscatter of claim 1 having a durability characterized by a loss of the maximal transmittance that remains below 2% after 500 dry brush cycles with sand, preferably below 1.5% after 500 dry brush cycles with sand.

20. Use of the highly transmitting glazing with optimized Hortiscatter of claim 1 as greenhouse glazing.
